(19) United States
(12) Patent Application Publication
(10) Pub. No.: US 2026/0205026 A1
(43) Pub. Date: Jul. 16, 2026

(54) Microphone power supply impedance switcher and method of use

(71) Applicants: Tom Hilbe, Glendale, CA (US); Mark Sampson, La Crescenta, CA (US)

(72) Inventors: Tom Hilbe, Glendale, CA (US); Mark Sampson, La Crescenta, CA (US)

(21) Appl. No.: 19/021,809

(22) Filed: Jan. 15, 2025

(51) Int. Cl. H02M 7/04; H02M 1/00; H02M 1/14; H02M 7/06; H04R 1/08

(52) U.S. Cl. CPC H02M 7/046; H02M 1/0067; H02M 1/009; H02M 1/14; H02M 7/06; H04R 1/08

(57) ABSTRACT

In a tube condenser microphone system our microphone power supply impedance switcher and method of use supplies direct current power to the microphone with either a low impedance solid-state output rectifier circuit, or with the addition (in series) of a higher impedance vacuum tube output rectifier circuit. The microphone power supply impedance switcher comprises an electronic circuit consisting of a solid-state rectifier, vacuum tube rectifier, and a two position manually operable switch by means of whose displacement the vacuum tube rectifier can be activated or bypassed. In the first position of the switch, only the solid-state portion of the circuit is activated and the microphone is supplied low impedance power. In the second position of the switch, the vacuum tube portion is activated in series, after the solid-state portion, to supply higher impedance power to the tube microphone.

### RELATED PATENT APPLICATIONS AND INCORPORATION BY REFERENCE

This is a Non-provisional Utility application, that claims priority based on, Pending U.S. Provisional Ser. No. 63/624,661, entitled “MICROPHONE POWER SUPPLY IMPEDANCE SWITCHER AND METHOD OF USE,” filed Jan. 24, 2024. These related patent applications are incorporated herein by reference and made a part of this application. If any conflict arises between the disclosure of the invention in this application and that in the related patent applications, the disclosure in this application shall govern. Moreover, any and all U.S. patents, U.S. patent applications, and other documents, hard copy or electronic, cited or referred to in this application are incorporated herein by reference and made a part of this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The words “consisting,” “consists of,” and other forms thereof, are intended to be equivalent in meaning and be closed ended in that an item or items following any one of these words is meant to be an exhaustive listing of such item or items and limited to only the listed item or items.

### BACKGROUND OF THE INVENTION

A vacuum tube condenser microphone circuit requires a direct current power source for operating the internal preamplifier, and polarizing the transducer element. Direct current power may be supplied to the tube microphone through a multi-conductor cable from a mixing console, an external microphone preamplifier, or an external standalone power supply. An example of a prior art microphone power supply is disclosed in U.S. Pat. No. 7,835,531 B2. Other examples of prior art microphone power supplies are disclosed in several commercially available products; namely, Behringer® MicroPower PS400 Phantom Power Supply, Mackie® M 48 Phantom Power Supply, ART® Phantom II Pro 2-channel 48V Phantom Power Supply. A problem with prior tube microphone power supplies is the direct current output voltage and impedance of the rectifier section cannot be varied. Our microphone power supply impedance switcher and method of use overcomes these limitations.

### SUMMARY

A vacuum tube condenser microphone contains an internal tube preamplifier powered from outside the microphone's body, through a multi-conductor cable attached to a direct current power source. When a solid-state rectifier supplies a low impedance direct current output to a vacuum tube microphone the capsule reacts fast to an incoming audio signal. When a vacuum tube rectifier circuit supplies direct current power to a vacuum tube microphone the rectifier's output impedance increases to a higher value, and the power supply reacts slower to an incoming audio signal. Depending on the program material being transduced by the tube microphone a slower (less harsh) or faster (sharper) attack and reaction time to the incoming signal is desirable. Our microphone power supply impedance switcher and method of use allows the ability to switch between the lower output impedance of a solid-state rectifier circuit, and the higher output impedance of a vacuum tube rectifier circuit. Our microphone power supply impedance switcher and method of use has one or more of the features depicted in the embodiments discussed in the section entitled “DETAILED DESCRIPTION OF SOME ILLUSTRATIVE EMBODIMENTS.” The claims that follow define our microphone power supply impedance switcher and method of use, distinguishing such claims from the prior art; however, without limiting the scope of our microphone power supply impedance switcher and method of use as expressed by these claims, in general terms, some, but not necessarily all, of their features are:
One, our microphone power supply impedance switcher and method of use gives the user the option of inserting a vacuum tube rectifier circuit in series after the solid-state rectifier portion of a microphone power supply circuit.

Two, when our microphone power supply impedance switcher and method of use inserts a vacuum tube rectifier circuit in series, after the solid-state rectifier portion of the power supply circuit, it creates a higher output impedance exhibited as a small “sag” in the microphone power supplies output voltage as it first comes under load from an incoming audio signal. The “sag” is noticeable on the very front edge, or what is considered the attack of the sound being transduced at that moment.

Three, by placing the vacuum tube rectifier circuit after the solid-state portion our microphone power supply impedance switcher and method of use, the “sag” in the microphone power supplies output voltage is enhanced, and the vacuum tube rectifier portion of the circuit is kept from working harder than required; thus ensuring longer tube life.

Four, the “sag” in the output voltage is a noticeable and desirable effect of our microphone power supply impedance switcher and method of use; wherein, an incoming audio signal received by the microphone's transducer element consequently draws more power from the microphone power supply; thereby, causing an immediate drop in output voltage supplied to the vacuum tube powering the microphone's transducer element.

Five, our microphone power supply impedance switcher and method of use allows the use of two styles of direct current outputs via a manually operated two position switch, (1) a singular solid-state rectifier; and, (2) a solid-state rectifier in series with a vacuum tube rectifier.

Six, our microphone power supply impedance switcher and method of use allows the additional option of a double-pole-double-throw manually operated switch to tap half the cathode output of the vacuum tube rectifier, or both sides of the cathode of the vacuum tube rectifier circuit in parallel (FIG. 4).

These features are not listed in any rank order nor is this list intended to be exhaustive.

### DESCRIPTION OF THE DRAWING

Some embodiments of our microphone power supply impedance switcher and method of use are discussed in detail in connection with the accompanying drawing, which is for illustrative purposes only. This drawing includes the following figures (Figs.), with like numerals and letters indicating like parts:

FIG. 1 is a schematic diagram illustrating the prior art manner of supplying direct current power to a tube condenser microphone in a conventional manner using a solid-state rectifier circuit.

FIG. 2 is a schematic diagram illustrating one embodiment of our circuit with a full-wave bridge rectifier in front of the tube rectifier with a switch to alternate between the full-wave bridge rectifier, or the full-wave bridge rectifier in series with the tube rectifier circuit.

FIG. 3 is a schematic diagram illustrating a second embodiment of our circuit with a center tapped full-wave rectifier circuit before the tube rectifier circuit, with a switch to alternate between the full-wave center tapped bridge rectifier, or the full-wave center tapped bridge rectifier in series with the tube rectifier circuit.

FIG. 4 is a schematic diagram illustrating an optional double pole/double throw (DPDT) switch SW2 connected to the tube rectifier circuit.

FIG. 5 is a block diagram showing the signal path of our circuit in the first setting

FIG. 5A is a block diagram showing the signal path of our circuit in the second setting

FIG. 5B is a block diagram showing the signal path of our circuit in the third setting

FIG. 6 is a diagram illustrating our microphone power supply in the first setting (Tube Bypassed)

FIG. 6A is a diagram illustrating our microphone power supply in the second setting (Half Tube Active)

FIG. 6B is a diagram illustrating our microphone power supply in the third setting (Full Tube Active)

### DETAILED DESCRIPTION OF SOME ILLUSTRATIVE EMBODIMENTS

Microphone power supply (prior art) 10
Solid State Rectifier (prior art) SSR
Microphone power supply MPS
Microphone power supply circuit 100a
Microphone power supply circuit 100b
Multi-conductor Cable MC
Vacuum Tube Microphone TM
Switch 1 SW1
Position 1 (bypass) L
Position 2 (engaged) R
Switch 2 (DPDT) SW2
Sub component of SW2 SW2a
Sub component of SW2 SW2b
Full-wave bridge FB1
Full-wave bridge center tapped rectifier Diodes D1 through D4
Center tap as ground (−) leg
Filter Section FS
Transformer 1 T1
Transformer 2 T2
Resistor R
Capacitor C
Cathode Tube CH
Diodes D
Vacuum Tube rectifier VT1
Power cord PC
Three-pronged grounding plug 200

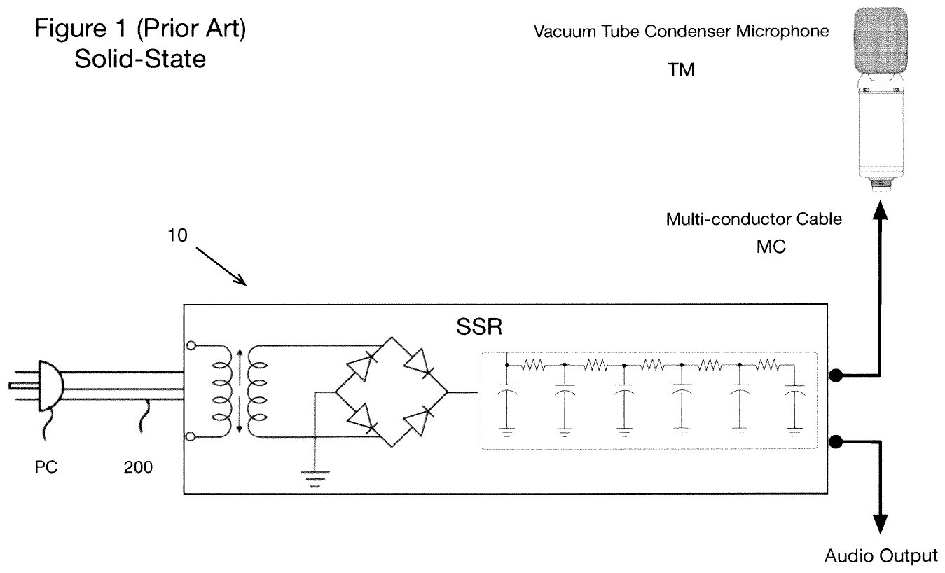

### FIG. 1 (Prior Art)

As illustrated in FIG. 1, and generally designated by the numeral 10, a conventional tube condenser microphone power supply is connected to an alternating current power cord PC terminating in a three-pronged grounding plug 200. The microphone power supply 10 provides includes a solid-state rectifier SSR for supplying direct current (DC) power, through a multi-conductor cable MC to the tube condenser microphone's TM internal vacuum tube circuitry. The audio signal transduced by the tube microphone TM flows through the same multi-conductor cable MC as the DC power source and is routed out of the microphone power supply 10 to a designated input source; for example a microphone preamplifier. In actual practice, when using the conventional tube condenser microphone power supply 10 there are several limitations. One problem with a conventional tube microphone power supply 10 is the direct current output voltage of the solid-state rectifier section is a fixed value that cannot be varied. A second problem with a conventional power supply 10 is the output impedance cannot be varied between low or high values. While our microphone power supply impedance switcher and method of use can function in the conventional prior art manner discussed herein, our microphone power supply impedance switcher and method of use includes additional improvements to overcome these conventional limitations.

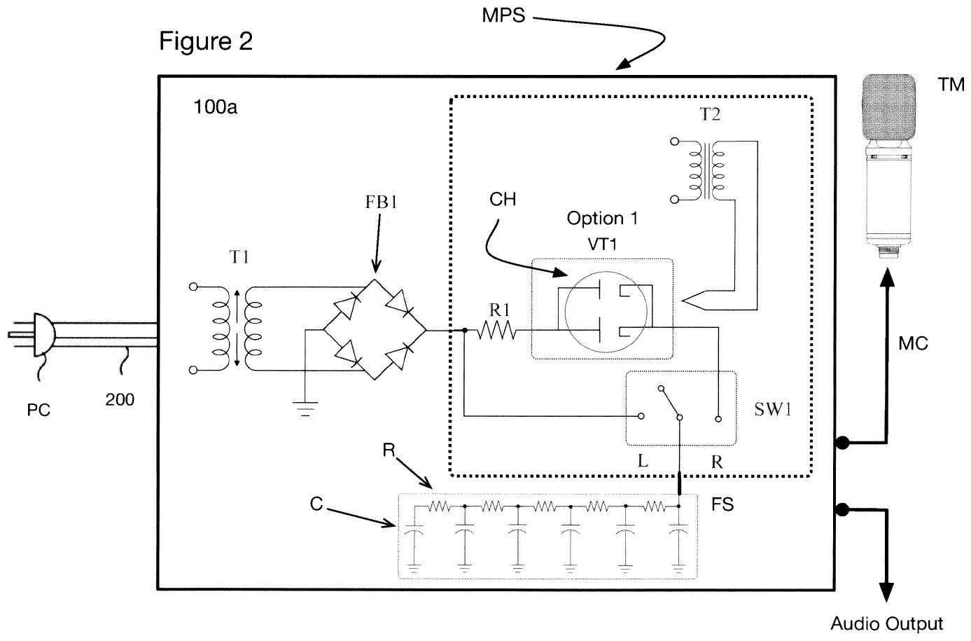

### FIG. 2: Embodiment 1

As illustrated in FIG. 2, and generally designated by the numeral 100a, there is schematically depicted our microphone power supply impedance switcher MPS connected to an alternating current power cord PC terminating in a three-pronged grounding plug 200.

Our microphone power supply MPS includes a transformer T1 for accepting an alternating current (AC) power source in communication with a solid-state full-wave bridge rectifier FB1 for its DC power output source.

The microphone power supply circuit 100a includes the vacuum tube rectifier circuit VT1, along with resistor R1 for enhancement of the desired “sag” effect, and adapting our microphone power supply MPS to various other brands and circuits requiring different DC power supply voltages.

The vacuum tube rectifier circuit VT1 includes a transformer T2 for heating the cathode filament CH of the vacuum tube rectifier circuit VT1, and must be selected, or made to match with the requirements of the vacuum tube utilized in the microphone power supply circuit 100a. For example, our microphone power supply MPS utilizes a 6AL5 type of vacuum tube for the vacuum tube rectifier VT1, which requires a 6 volt transformer T2 to heat the cathode CH.

The microphone power supply circuit 100a contains a filter section FS, including resistors R and capacitors C for filtering any remaining AC current ripple in the microphone power supply MPS, and minimizing any DC ripple being injected into the audio portion of the power supply circuit 100a. For example, our microphone power supply MPS utilizes resistors R and capacitors C with values of 5.6 K ohms and 22 uf respectively.

Option 1 of the microphone power supply circuit 100a contains a manually operable two-position switch SW1. When the switch SW1 is in position one L only the full-wave bridge rectifier FB1 is activated and the vacuum tube rectifier circuit VT1 is bypassed. When the switch SW1 is in switch position two R both the full-wave bridge rectifier circuit FB1 and vacuum tube rectifier circuit VT1 are activated in series.

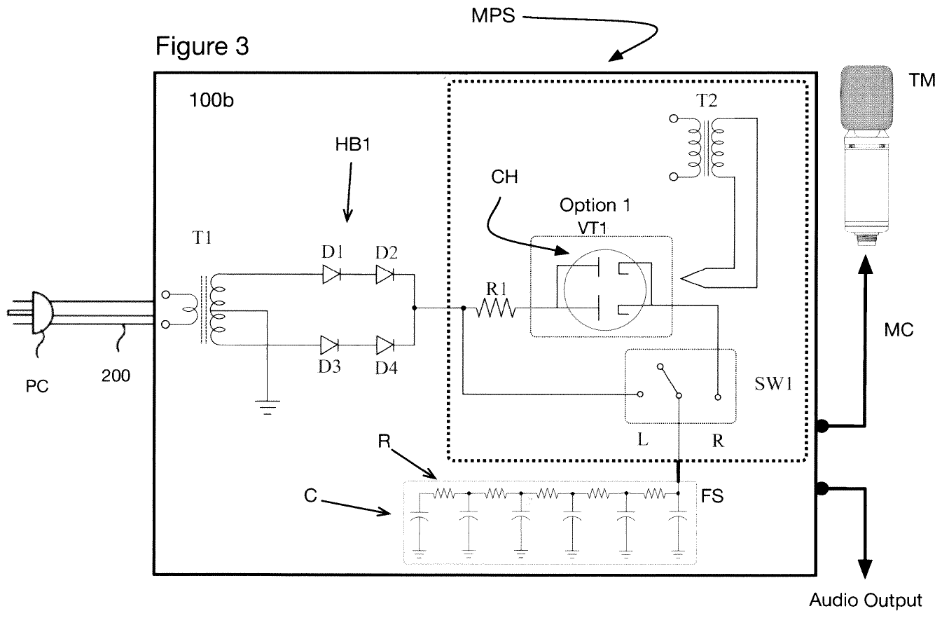

### FIG. 3: Embodiment 2

As illustrated in FIG. 3, and generally designated by the numeral 100b, there is schematically depicted our microphone power supply MPS connected to an alternating current power cord PC terminating in a three-pronged grounding plug 200.

Our microphone power supply MPS includes a transformer T1 for accepting an alternating current (AC) power source in communication with a diode based, center tapped, full-wave bridge rectifier HB1 consisting of Diodes D (D1 through D4) for its DC power output source.

The microphone power supply circuit 100b includes the vacuum tube rectifier circuit VT1, along with resistor R1 for enhancement of the desired “sag” effect, and adapting our microphone power supply MPS to various other brands and circuits requiring different DC power supply voltages.

The vacuum tube rectifier circuit VT1 includes a transformer T2 for heating the cathode filament CH of the vacuum tube rectifier circuit VT1, and must be selected, or made to match with the requirements of the vacuum tube utilized in the microphone power supply circuit 100b. For example, our microphone power supply MPS utilizes a 6AL5 type of vacuum tube for the vacuum tube rectifier VT1, which requires a 6 volt transformer T2 to heat the cathode CH.

The microphone power supply circuit 100b contains a filter section FS, including resistors R and capacitors C for filtering any remaining AC current ripple in the microphone power supply MPS, and minimizing any DC ripple being injected into the audio portion of the power supply circuit 100b. For example, our microphone power supply MPS utilizes resistors R and capacitors C with values of 5.6 K ohms and 22 uf respectively.

Option 1 of the microphone power supply circuit 100b contains a manually operable two-position switch SW1. When the switch SW1 is in position one L only the diode based full-wave bridge rectifier HB1 is activated and the vacuum tube rectifier circuit VT1 is bypassed. When the switch SW1 is in switch position two R both the diode based full-wave bridge rectifier circuit HB1 and vacuum tube rectifier circuit VT1 are activated in series.

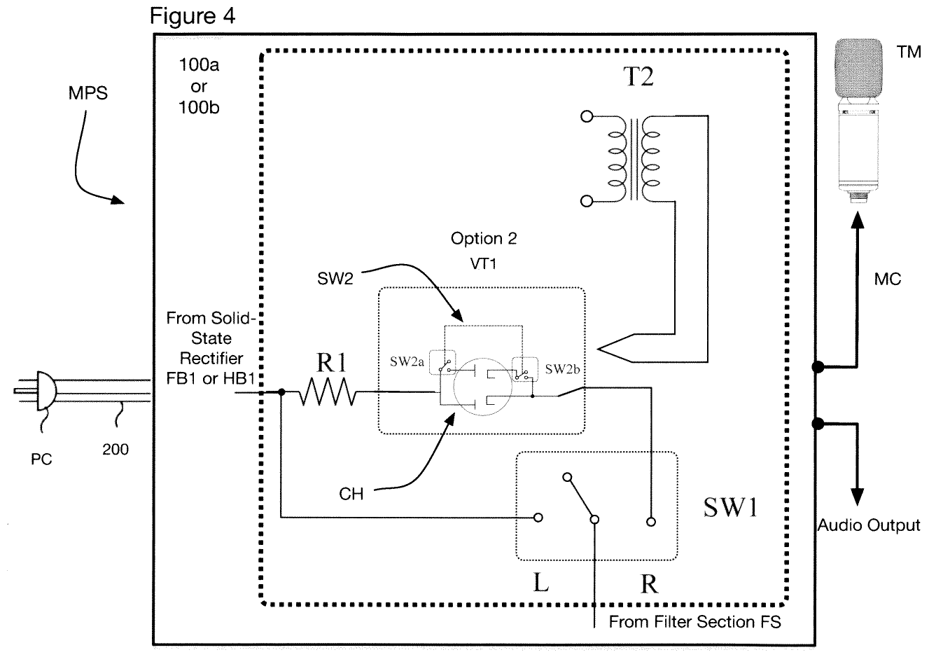

### FIG. 4

As illustrated by FIG. 4, both of the microphone power supply circuits, 100a or 100b, may include the addition of Option 2 allowing use of one half, or both halves of the cathode CH in parallel. With only one half of the cathode CH in use, the end result is that of Option 1 (FIGS. 2 and 3). However, Option 2 includes a two-position manually operable double pole/double throw (DPDT) switch SW2 in communication with both sections of the cathode element CH of the vacuum tube rectifier VT1. When switch SW2 is in position one SW2a, half of the cathode CH of the vacuum tube rectifier circuit VTI is used. When switch SW2 is in position two SW2b (with the switch closed) both sides of the cathode CH of the vacuum tube rectifier circuit VT1 are used in parallel to further lower the output impedance value of the microphone power supply MPS. This impedance value falls between the value of the original solid-state rectifier portion (FB1 or HB1) and only half of the tube being utilized in the vacuum tube rectifier circuit VT1.

### Method of Switching Impedance of our Power Supply

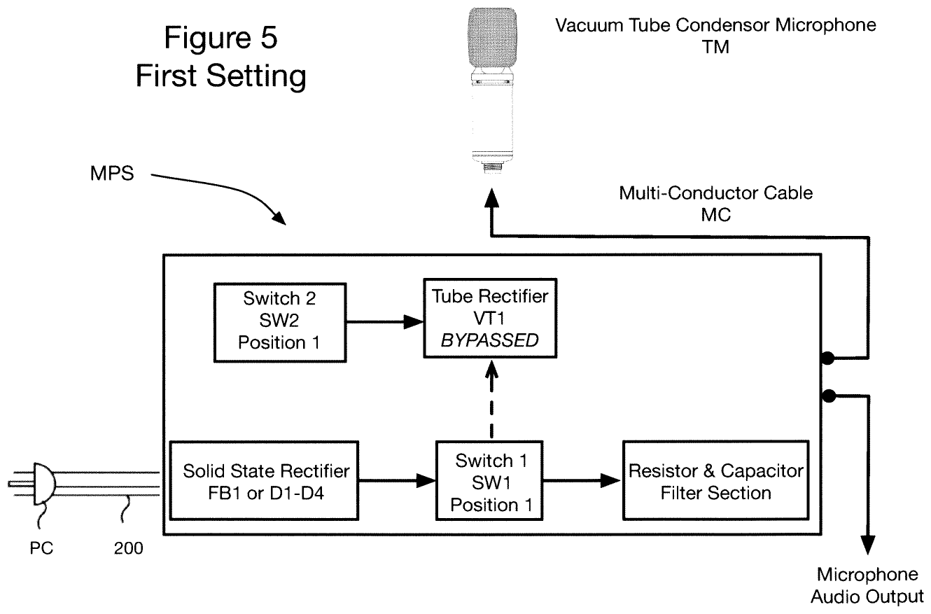

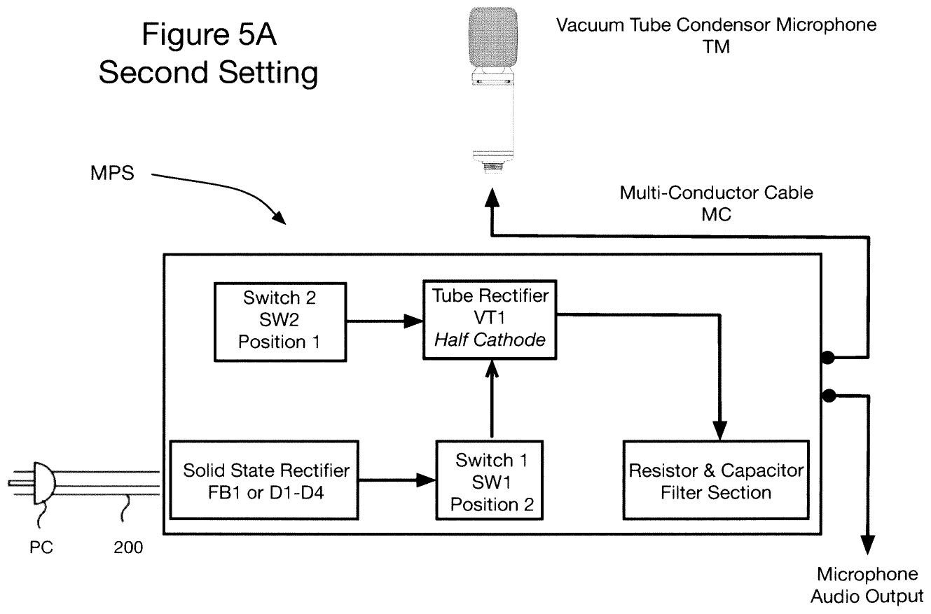

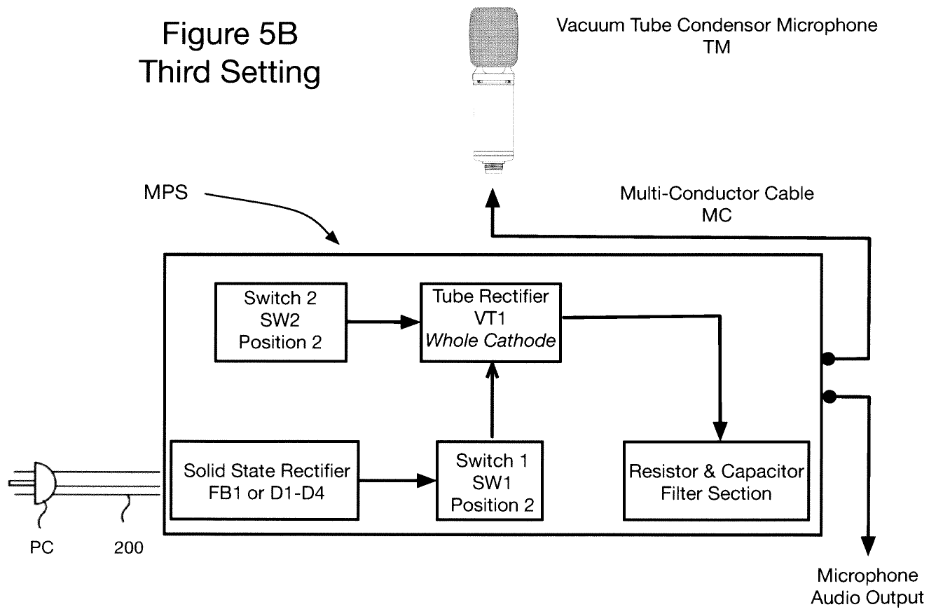

### FIGS. 5, 5a, and 5b

For purposes of illustration, in FIGS. 5, 5A, and 5B our microphone power supply impedance switcher and method of use is discussed; wherein, two separate manually operable switches (SW1 and SW2) allow the user to toggle between; a first setting with a solid state rectifier output section only, a second setting with a solid-state rectifier output into a vacuum tube rectifier section with half of the cathode engaged, and, a third setting with a solid-state rectifier output, FB1 or HB1, into a vacuum tube rectifier section VT1 with both halves of the cathode CH engaged.

As shown in FIG. 5 First Setting, the switch SW1 is in position one (L on FIGS. 2 and 3); wherein, only the solid-state portion of the rectifier circuit (FB1 or HB1) is activated, and the vacuum tube rectifier circuit VT1, and switch SW2 are bypassed. As shown in FIG. 5A Second Setting, the switch SW1 is in position two (R on FIGS. 2 and 3); wherein, the solid-state portion of the rectifier circuit (FB1 or HB1) is in series with the vacuum tube rectifier circuit VT1, and switch SW2 is in position one (SW2a FIG. 4), allowing only half of the cathode tube CH of the vacuum tube rectifier circuit VT1 to be utilized. As shown in FIG. 5B Third Setting, the switch SW1 is in position two (R on FIGS. 2 and 3); wherein, the solid-state portion of the rectifier circuit (FB1 or HB1) is in series with the vacuum tube rectifier circuit VT1, and switch SW2 is in position two (SW2b FIG. 4), allowing the whole cathode tube CH of the vacuum tube rectifier circuit VT1 to be utilized.

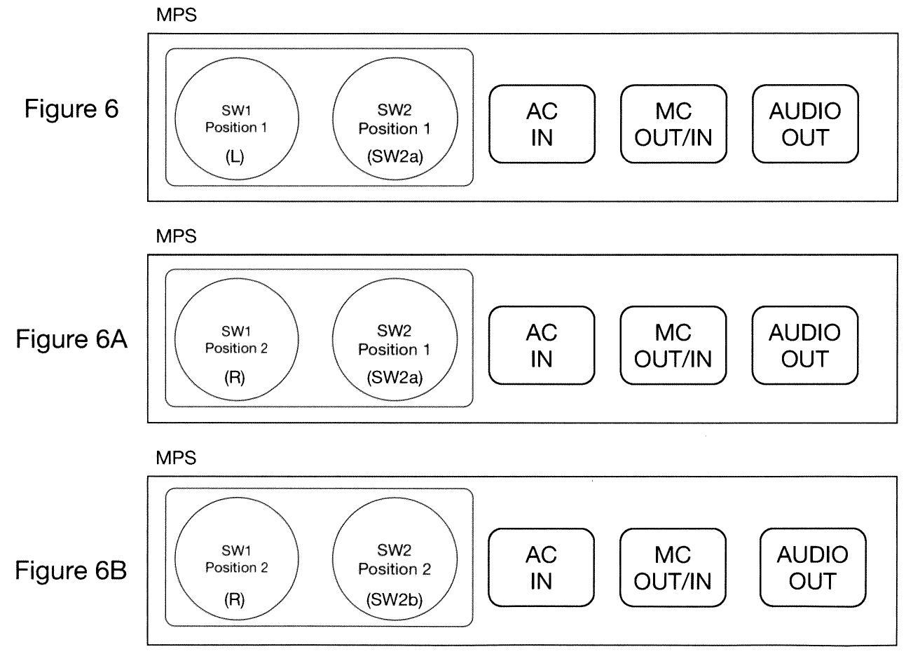

### FIGS. 6, 6a, and 6b

As illustrated in FIGS. 6, 6A, and 6B, the microphone power supply MPS has a switch SW1, switch SW2, an AC receptacle, a multi-conductor cable jack, and an audio out jack. FIG. 6 demonstrates the microphone power supply MPS in the First Setting; with the switch SW1 is in position one (L FIGS. 2, 3 4) and the vacuum tube rectifier circuit VT1 bypassed. FIG. 6A demonstrates the microphone power supply MPS in the Second Setting; switch SW1 is in position two (R FIGS. 2 and 3) and the vacuum tube rectifier circuit VT1 is inserted into the circuit with switch SW2 in position one (SW2a FIG. 4, half cathode in use). FIG. 6A demonstrates the microphone power supply MPS in the Third Setting; switch SW1 is in position two (R FIGS. 2, 3, 4) and the vacuum tube rectifier circuit VT1 is inserted into the circuit with switch SW2 in position two (SW2b FIG. 4, whole cathode in use).

### Method of Use One

1. The microphone power supply MPS is conventionally plugged into a utility AC power line.

2. A multi-conductor cable MC is used to interconnect the microphone power supply MPS and vacuum tube condenser microphone TM.

3. A technician monitors the audio output signal of the tube microphone TM coming from the microphone power supply MPS with the switch SW1 in position one (FIGS. 5 and 6); wherein, the vacuum tube circuit VT1 is bypassed, and switch SW2 bypassed. If it is determined there is not enough “sag” effect exhibited upon the tube microphone TM, the vacuum tube rectifier VT1 can be inserted into either power supply circuit 100a or 100b.

4. To activate the vacuum tube rectifier VT1, a technician manually operates the switch SW1 into position two, with switch SW2 in position one (FIGS. 5A and 6A). Once the vacuum tube rectifier VT1 is activated, the output of the solid-state rectifier circuit FB1 or HB1, is internally routed through the vacuum tube rectifier circuit VT1, prior to connection with the tube microphone TM via the multi-conductor cable MC. This increases the output impedance of the microphone power supply MPS and decreases the instantaneous value of the available current of the final rectifier portion of the microphone power supply circuit 100a or 100b.

5. Upon activating the vacuum tube rectifier circuit VT1, switch SW1 in position two, and SW2 in position one (FIGS. 5A and 6A), a technician monitors the audio output signal of the vacuum tube condenser microphone TM and ascertains if there is too much “sag.”

6. If less “sag” is required the technician can use the second method discussed below.

### Method of Use Two

1. Similar to Method One, the microphone power supply MPS is conventionally plugged into a utility AC power line.

2. A multi-conductor cable MC is used to interconnect the microphone power supply MPS and vacuum tube condenser microphone TM.

3. A technician monitors the audio output signal of the tube microphone TM coming from the microphone power supply MPS with switch SW1 in position two, and switch SW2 in position one (FIGS. 5A and 6A).

4. If the technician determines there is too much “sag” effect exhibited upon the tube microphone TM the second half of the cathode CH contained in the vacuum tube rectifier VT1 can be activated in parallel to further decrease the output impedance of the vacuum tube rectifier VT1. This alters the internal impedance value of vacuum tube rectifier circuit VT1 to be roughly half of that with only one side of the cathode CH in use.

6. To activate the second half of the cathode CH of the vacuum tube rectifier VT1, a technician manually actuates witch SW2 into position two (FIGS. 5B and 6B). Once the second half of the cathode CH of the vacuum tube rectifier VT1 is activated, the output of both sides of the tube are internally routed through the power supply, prior to connection with the tube microphone TM via the multi-conductor cable MC.

### Scope of the Invention

The above presents a description of the best mode we contemplate for carrying out our MICROPHONE POWER SUPPLY IMPEDANCE SWITCHER AND METHOD OF USE, and of the manner and process of making and using it, in such full, clear, concise, and exact terms as to enable a person skilled in the art to make and use our MICROPHONE POWER SUPPLY IMPEDANCE SWITCHER AND METHOD OF USE; however, our disclosure is susceptible to modifications and alternate constructions from the illustrative embodiments discussed above which are fully equivalent. Consequently, it is not the intention to limit our MICROPHONE POWER SUPPLY IMPEDANCE SWITCHER AND METHOD OF USE to the particular embodiments disclosed. On the contrary, our intention is to cover all modifications and alternate constructions coming within the spirit and scope of our MICROPHONE POWER SUPPLY IMPEDANCE SWITCHER AND METHOD OF USE as generally expressed by the following claims, which particularly point out and distinctly claim the subject matter of our invention:

1. A microphone power supply impedance switcher for use with tube-based condenser microphones, comprising:
an AC receptacle
an alternating current (AC) power cord terminating in a three-pronged grounding plug;
a multi-conductor cable jack;
an audio output jack;
a microphone power supply circuit including:
a first transformer configured to accept an alternating current power source;
a solid-state full-wave bridge rectifier electrically connected to the first transformer, configured to generate a direct current (DC) power output;
a vacuum tube rectifier circuit including a resistor and a second transformer for heating a cathode filament of the vacuum tube rectifier circuit;
a filter section comprising a resistor and a capacitor network; and
a manually operable two-position switch configured to:
activate only the solid-state full-wave bridge rectifier when in a first position; and,
activate both the solid-state full-wave bridge rectifier and the vacuum tube rectifier circuit in series when in a second position.

2. The microphone power supply impedance switcher of claim 1 where when the manually operable two-position switch is in a first position, the solid-state full-wave bridge rectifier is activated to supply low impedance DC power to a tube-based condenser microphone while the vacuum tube rectifier circuit is bypassed.

3. The microphone power supply impedance switcher of claim 1 where when the manually operable two-position switch is in a second position, the solid-state full-wave bridge rectifier and the vacuum tube rectifier circuit are activated in series to supply high impedance DC power to a tube-based condenser microphone.

4. The microphone power supply impedance switcher of claim 1 where the resistor associated with the vacuum tube rectifier circuit enhances a desired “sag” effect, and adapts the microphone power supply impedance switcher to various other brands and circuits requiring different DC power supply voltages.

5. The microphone power supply impedance switcher of claim 1 where the filter section is configured to filter AC ripple and minimize DC ripple injected into the audio portion of the circuit.

6. A microphone power supply impedance switcher for use with tube-based condenser microphones, comprising:
an AC receptacle
an alternating current (AC) power cord terminating in a three-pronged grounding plug;
a multi-conductor cable jack;
an audio output jack;
a microphone power supply circuit including:
a first transformer configured to accept an alternating current power source;
a diode-based center-tapped full-wave bridge rectifier electrically connected to the first transformer, comprising diodes arranged to generate a direct current (DC) power output;
a vacuum tube rectifier circuit including a second transformer for heating a cathode filament of the vacuum tube rectifier circuit;
a filter section comprising a resistor and a capacitor network; and
a manually operable two-position switch configured to:
activate only the diode-based center-tapped full-wave bridge rectifier when in a first position; and,
activate both the diode-based center-tapped full-wave bridge rectifier and the vacuum tube rectifier circuit in series when in a second position.

7. The microphone power supply impedance switcher of claim 6 where when the manually operable two-position switch is in a first position, the diode-based center-tapped full-wave bridge rectifier is activated to supply low impedance DC power to a tube-based condenser microphone while the vacuum tube rectifier circuit is bypassed.

8. The microphone power supply impedance switcher of claim 6 where when the manually operable two-position switch is in a second position, the diode-based center-tapped full-wave bridge rectifier and the vacuum tube rectifier circuit are activated in series to supply high impedance DC power to a tube-based condenser microphone.

9. The microphone power supply impedance switcher of claim 6 where the resistor associated with the vacuum tube rectifier circuit enhances a desired “sag” effect, and adapts the microphone power supply impedance switcher to various other brands and circuits requiring different DC power supply voltages.

10. The microphone power supply impedance switcher of claim 6 where the filter section is configured to filter AC ripple and minimize DC ripple injected into the audio portion of the circuit.

11. The microphone power supply impedance switcher of claim 6 including a second two-position manually operable double pole/double throw (DPDT) switch in communication with both sections of the cathode element of the vacuum tube rectifier;
said second switch when in a first position, only half of the cathode of the vacuum tube rectifier circuit is used;
said second switch when in a second position, both sides of the cathode of the vacuum tube rectifier circuit are used in parallel to further lower the output impedance value of the microphone power supply circuit.

12. A method of supplying variable impedance power to a tube-based condenser microphone, comprising:
providing a (AC) power cord terminating in a three-pronged grounding plug to provide power to the microphone power supply circuit;
providing a microphone power supply circuit including a solid-state rectifier circuit, a vacuum tube rectifier circuit, and a two-position manually operable switch;
providing a multi-conductor cable to interconnect the microphone power supply and a vacuum tube condenser microphone;
connecting the microphone power supply circuit to the multi-conductor cable, and connecting the multi-conductor cable to a vacuum tube condenser microphone;
positioning the manually operable switch in a first position to activate the solid-state rectifier circuit and bypass the vacuum tube rectifier circuit, supplying low impedance power to the microphone;
monitoring the audio output signal of the tube microphone;
determining if a desired “sag” effect is present in the audio output signal of the tube microphone;
positioning the manually operable switch in a second position to activate the vacuum tube rectifier circuit in series with the solid-state rectifier circuit, supplying higher impedance power to the microphone;
re-monitoring the audio output signal of the tube microphone with the vacuum tube rectifier circuit activated, and determining if the sag effect is excessive;
adjusting the circuit configuration, as needed, by deactivating or modifying the
impedance of the vacuum tube rectifier circuit to achieve a balanced sag effect suitable for the tube microphone's operational requirements.

13. The method of claim 12 where said means of supplying higher impedance power to the microphone includes a second two-position manually operable double pole/double throw (DPDT) switch in communication with both sections of the cathode element of the vacuum tube rectifier;
said second switch when in a first position, only half of the cathode of the vacuum tube rectifier circuit is used;
said second switch when in a second position, both sides of the cathode of the vacuum tube rectifier circuit are used in parallel to further decrease the output impedance value of the microphone power supply circuit.
